(19) United States
(12) Patent Application Publication
(10) Pub. No.: US 2023/0280745 A1
(43) Pub. Date: Sep. 7, 2023

(54) FLIGHT CONTROL METHOD, DEVICE, AIRCRAFT, SYSTEM, AND STORAGE MEDIUM

(71) Applicant: SZ DJI TECHNOLOGY CO., LTD., Shenzhen (CN)

(72) Inventors: Jie QIAN, Shenzhen (CN); Xia CHEN, Shenzhen (CN); Liliang ZHANG, Shenzhen (CN); Cong ZHAO, Shenzhen (CN); Zhengzhe LIU, Shenzhen (CN); Sijin LI, Shenzhen (CN); Lei PANG, Shenzhen (CN); Haonan LI, Shenzhen (CN)

(21) Appl. No.: 18/316,399

(22) Filed: May 12, 2023

Related U.S. Application Data
(63) Continuation of application No. 16/935,680, filed on Jul. 22, 2020.
Application No. 16/935,680 is a continuation of application No. PCT/CN2018/073877, filed on Jan. 23, 2018.

(51) Int. Cl. G05D 1/00; B64C 39/02; G06F 3/01; G06V 40/20; G06V 40/10; G06V 20/13; G06V 20/17

(52) U.S. Cl. CPC G05D 1/0016; B64C 39/024; G05D 1/0011; G05D 1/0094; G06F 3/017; G06V 40/28; G06V 40/107; G06V 20/13; G06V 20/17; B64U 2101/30

(57) ABSTRACT

A method is provided for controlling flight of an aircraft carrying an imaging device. The imaging device is mounted at a gimbal. The method includes in response to receiving a triggering operation that triggers the aircraft to operate in an image control mode, obtaining an environment image captured by the imaging device, recognizing a gesture of a target user in the environment image, and in response to recognizing that the gesture of the target user is a start-flight gesture, generating a takeoff control command to control the aircraft to take off. Obtaining the environment image includes after obtaining the triggering operation, controlling the gimbal to rotate to control the imaging device to scan and photograph in a predetermined photographing range, and obtaining the environment image including a characteristic part of the target user that is captured by the imaging device through scanning and photographing in the predetermined photographing range.

### CROSS-REFERENCE TO RELATED APPLICATION

This application is a continuation of application Ser. No. 16/935,680, filed on Jul. 22, 2020, which is a continuation application of International Application No. PCT/CN2018/073877, filed on Jan. 23, 2018, the entire contents of both of which are incorporated herein by reference.

### TECHNICAL FIELD

The present disclosure relates to the technology field of controls and, more particularly, to a flight control method, a device, an aircraft, a system, and a storage medium.

### BACKGROUND

As the computer technology advances, unmanned aircrafts are being rapidly developed. The flight of an unmanned aircraft is typically controlled by a flight controller or a mobile device that has control capability. However, before a user can use the flight controller or the mobile device to control the flight of the aircraft, the user has to learn related control skills. The cost of learning is high, and the operating processes are complex. Therefore, it has been a popular research topic to study how to better control an aircraft.

### SUMMARY

In accordance with an aspect of the present disclosure, there is provided a method for controlling flight of an aircraft carrying an imaging device. The method includes obtaining an environment image captured by the imaging device. The method also includes determining a characteristic part of a target user based on the environment image, determining a target image area based on the characteristic part, and recognizing a control object of the target user in the target image area. The method further includes generating a control command based on the control object to control the flight of the aircraft.

In accordance with another aspect of the present disclosure, there is also provided a device for controlling flight of an aircraft carrying an imaging device. The device includes a storage device configured to store instructions. The device also includes a processor configured to execute the instructions to obtain an environment image captured by the imaging device. The processor is also configured to determine a characteristic part of a target user based on the environment image, determine a target image area based on the characteristic part, and recognize a control object of the target user in the target image area. The processor is further configured to generate a control command based on the control object to control the flight of the aircraft.

According to the present disclosure, a flight control device may obtain an environment image captured by an imaging device. The flight control device may determine a characteristic part of a target user, and determine a target image area based on the characteristic part. The flight control device may recognize or identify a control object of the target user in the target image area, thereby generating a control command based on the control object to control the flight of the aircraft. Through the disclosed methods, fast control of the aircraft can be achieved, and the operating efficiency relating to controlling the flight of the aircraft, photographing, and landing may be increased.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1a is a schematic illustration of a flight control system, according to an example embodiment.

FIG. 1B is a schematic illustration of control of the flight of an aircraft, according to an example embodiment.

FIG. 2 is a flow chart illustrating a method for flight control, according to an example embodiment.

FIG. 3 is a flow chart illustrating a method for flight control, according to another example embodiment.

FIG. 4 is a flow chart illustrating a method for flight control, according to another example embodiment.

FIG. 5 is a schematic diagram of a flight control device, according to an example embodiment.

FIG. 6 is a schematic diagram of a flight control device, according to another example embodiment.

### DETAILED DESCRIPTION OF THE EMBODIMENTS

Technical solutions of the present disclosure will be described in detail with reference to the drawings, in which the same numbers refer to the same or similar elements unless otherwise specified. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless.

When a first component is referred to as “disposed,” “located,” or “provided” on a second component, the first component may be directly disposed, located, or provided on the second component or may be indirectly disposed, located, or provided on the second component via an intermediate component. The term “on” does not necessarily mean that the first component is located higher than the second component. In some situations, the first component may be located higher than the second component. In some situations, the first component may be disposed, located, or provided on the second component, and located lower than the second component. In addition, when the first item is disposed, located, or provided “on” the second component, the term “on” does not necessarily imply that the first component is fixed to the second component. The connection between the first component and the second component may be any suitable form, such as secured connection (fixed connection) or movable contact.

When a first component is referred to as “disposed,” “located,” or “provided” in a second component, the first component may be partially or entirely disposed, located, or provided in, inside, or within the second component. When a first component is coupled, secured, fixed, or mounted “to” a second component, the first component may be is coupled, secured, fixed, or mounted to the second component from any suitable directions, such as from above the second component, from below the second component, from the left side of the second component, or from the right side of the second component.

The terms “perpendicular,” “horizontal,” “left,” “right,” “up,” “upward,” “upwardly,” “down,” “downward,” “downwardly,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure.

In addition, the singular forms “a,” “an,” and “the” are intended to include the plural forms as well, unless the context indicates otherwise. And, the terms “comprise,” “comprising,” “include,” and the like specify the presence of stated features, steps, operations, elements, and/or components but do not preclude the presence or addition of one or more other features, steps, operations, elements, components, and/or groups. The term “and/or” used herein includes any suitable combination of one or more related items listed. For example, A and/or B can mean A only, A and B, and B only. The symbol “I” means “or” between the related items separated by the symbol. The phrase “at least one of” A, B, or C encompasses all combinations of A, B, and C, such as A only, B only, C only, A and B, B and C, A and C, and A, B, and C. In this regard, A and/or B can mean at least one of A or B.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

The following descriptions explain example embodiments of the present disclosure, with reference to the accompanying drawings. Unless otherwise noted as having an obvious conflict, the embodiments or features included in various embodiments may be combined.

The following embodiments do not limit the sequence of execution of the steps included in the disclosed methods. The sequence of the steps may be any suitable sequence, and certain steps may be repeated.

The flight control methods of the present disclosure may be executed by a flight control device. The flight control device may be provided in the aircraft (e.g., an unmanned aerial vehicle) that may be configured to capture images and/or videos through an imaging device carried by the aircraft. The flight control methods disclosed herein may be applied to control the takeoff, flight, landing, imaging, and video recording operations. In some embodiments, the flight control methods may be applied to other movable devices such as robots that can autonomously move around. Next, the disclosed flight control methods applied to an aircraft are described as an example implementation.

In some embodiments, the flight control device may be configured to control the takeoff of the aircraft. The flight control device may also control the aircraft to operate in an image control mode if the flight control device receives a triggering operation that triggers the aircraft to enter the image control mode. In the image control mode, the flight control device may obtain an environment image captured by an imaging device carried by the aircraft. The environment image may be a preview image captured by the imaging device before the aircraft takes off. The flight control device may recognize a hand gesture of a control object of a target user in the environment image. If the flight control device recognizes or identifies that the hand gesture of the control object is a start-flight hand gesture, the flight control device may generate a takeoff control command to control the takeoff of the aircraft.

In some embodiments, the triggering operation may include one or more of: a point-click operation on a power button of the aircraft, a double-click operation of the power button of the aircraft, a shaking operation of the aircraft, a voice input operation, and a fingerprint input operation. The triggering operation may also include one or more of a scanning operation of a characteristic object, or an interactive operation of a smart accessory (e.g., smart eye glasses, a smart watch, a smart band, etc.). The present disclosure does not limit the triggering operation.

In some embodiments, the start-flight hand gesture may be any specified hand gesture performed by the target user, such as an “OK” hand gesture, a scissor hand gesture, etc. The present disclosure does not limit the start-flight hand gesture.

In some embodiments, the target user may be a human. The control object may be a part of the human, such as a palm of the target user or other parts or regions of the body, such as a characteristic part of the body, e.g., a face portion, a head portion, and a shoulder portion, etc. The present disclosure does not limit the target user and the control object.

For illustration purposes, it is assumed that the triggering operation is the double-click of the power button of the aircraft, the target user is a human, the control object is a palm of the target user, and the start-flight hand gesture is the “OK” hand gesture. If the flight control device detects the double-click operation on the power button of the aircraft performed by the target user, the flight control device may control the aircraft to enter the image control mode. In the image control mode, the flight control device may obtain an environment image captured by the imaging device carried by the aircraft. The environment image may be a preview image for control analysis, and may not be an image that needs to be stored. The preview image may include the target user. The flight control device may perform a hand gesture recognition of the palm of the target user in the environment image in the image control mode. If the flight control device recognizes or identifies that the hand gesture of the palm of the target user is an “OK” hand gesture, the flight control device may generate a takeoff control command to control the takeoff of the aircraft.

In some embodiments, after the flight control device receives the triggering operation and enters the image control mode, the flight control device may recognize or identify the control object of the target user. In some embodiments, the flight control device may obtain the environment image captured by the imaging device carried by the aircraft. The environment image may be a preview image captured before the takeoff of the aircraft. The flight control device may determine a characteristic part of the target user from the preview image. The flight control device may determine a target image area based on the characteristic part, and recognize or identify the control object of the target user in the target image area. For example, assuming the control object is the palm of the target user, the flight control device may obtain the environment image captured by the imaging device carried by the aircraft. The environment image may be a preview image captured before the takeoff of the aircraft. Assuming the flight control device may determine, from the preview image, that the characteristic part of the target user is a human body, then based on the human body of the target user, the flight control device may determine a target image area in the preview image in which the human body is located. The flight control device may further recognize or identify the palm of the target user in the target image area in which the human body is located.

In some embodiments, during the flight of the aircraft, the flight control device may control the imaging device to capture a flight environment image. The flight control device may perform a hand gesture recognition of the control object of the target user in the flight environment image. The flight control device may determine a flight control hand gesture based on the hand gesture recognition. The flight control device may generate a control command based on the flight control hand gesture to control the aircraft to perform an action corresponding to the control command.

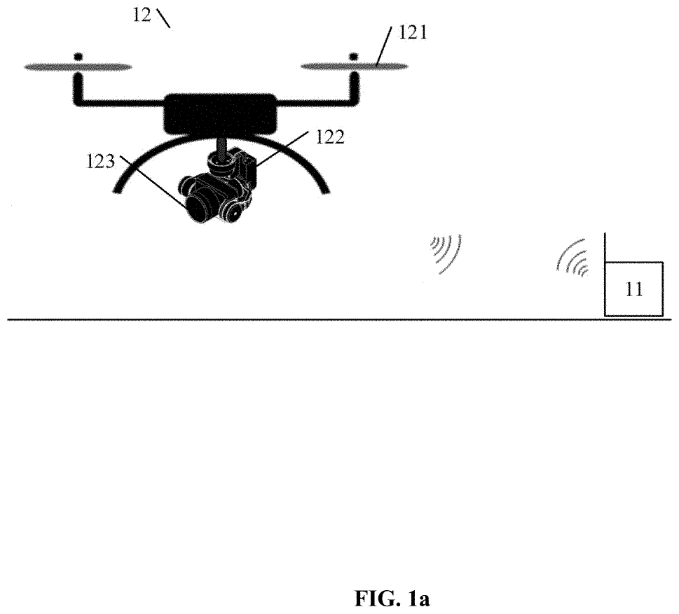

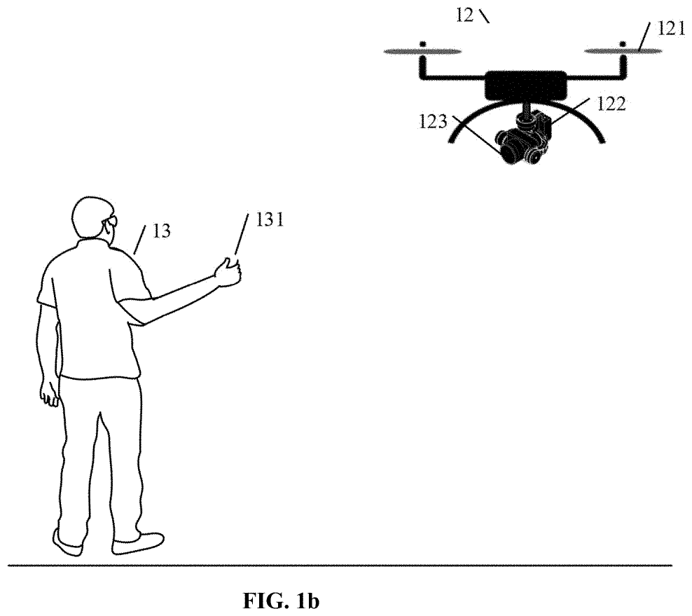

FIG. 1a is a schematic illustration of a flight control system. The flight control system may include a flight control device 11 and an aircraft 12. The flight control device 11 may be provided on the aircraft 12. For the convenience of illustration, the aircraft 12 and the flight control device 11 are separately shown. The communication between the aircraft 12 and the flight control device 11 may include at least one of a wired communication or a wireless communication. The aircraft 12 may be a rotorcraft unmanned aerial vehicle, such as a four-rotor unmanned aerial vehicle, a six-rotor unmanned aerial vehicle, or an eight-rotor unmanned aerial vehicle. In some embodiments, the aircraft 12 may be a fixed-wing unmanned aerial vehicle. The aircraft 12 may include a propulsion system 121 configured to provide a propulsion force for the flight. The propulsion system 121 may include one or more of a propeller, a motor, and an electric speed control (“ESC”). The aircraft 12 may also include a gimbal 122 and an imaging device 123. The imaging device 123 may be carried by the body of the aircraft 12 through the gimbal 122. The imaging device 123 may be configured to capture the preview image before the takeoff of the aircraft 12, and to capture images and/or videos during the flight of the aircraft 12. The imaging device may include, but not be limited to, a multispectral imaging device, a hyperspectral imaging device, a visible-light camera, or an infrared camera. The gimbal 122 may be a multi-axis transmission and stability-enhancement system. The motor of the gimbal may compensate for an imaging angle of the imaging device by adjusting the rotation of one or more rotation axes. The gimbal may reduce or eliminate the vibration or shaking of the imaging device through a suitable buffer or damper mechanism.

In some embodiments, after the flight control device 11 receives the triggering operation that triggers the aircraft 12 to enter the image control mode, and after the aircraft 12 enters the image control mode, and before controlling the aircraft 12 to take off, the flight control device 12 may start the imaging device 123 carried by the aircraft 12, and control the rotation of the gimbal 122 carried by the aircraft 12 to adjust the attitude angle(s) of the gimbal 122, thereby controlling the imaging device 123 to scan and photograph in a predetermined photographing range. The imaging device may scan and photograph in the predetermined photographing range to capture the characteristic part of the target user in the environment image. The flight control device 11 may obtain the environment image including the characteristic part of the target user that is obtained by the imaging device by scanning and photographing in the predetermined photographing range. The environment image may be a preview image captured by the imaging device 123 before the takeoff of the aircraft 12.

In some embodiments, before the flight control device 11 controls the aircraft 12 to take off, and when the flight control device recognizes the control object of the target user based on the environment image, if the flight control device 11 detects that a status parameter of the target user satisfies a first predetermined condition, the flight control device 11 may determine that the characteristic part of the target user is a first characteristic part. Based on the first characteristic part of the target user, the flight control device 11 may determine a target image area where the first characteristic part is located. The flight control device 11 may recognize the control object of the target user in the target image area. In some embodiments, the status parameter of the target user may include a proportion of a size of an image area in which the target user is located in the environment image (e.g., relative to the size of the environment image). The first predetermined condition that the status parameter of the target user may satisfy may include: the proportion of the size of the image area in which the target user is located in the environment image is smaller than or equal to a first predetermined proportion value. In some embodiments, the status parameter of the target user may include a distance between the target user and the aircraft. The first predetermined condition that the status parameter of the target user may satisfy may include: the distance between the target user and the aircraft is greater than or equal to a first predetermined distance. In some embodiments, the first characteristic part may include a human body of the target user, or the first characteristic part may be other body parts of the target user. The present disclosure does not limit the first characteristic part. For example, assuming the first predetermined proportion value is ¼, and the first characteristic part is the human body of the target user, if the flight control device detects that in the environment image captured by the imaging device, the proportion of the size of the image area where the target user is located in the environment image is smaller than ¼, then the flight control device may determine that the characteristic part of the target user is the human body. The flight control device may determine the target image area in which the human body is located based on the human body of the target user. The flight control device may recognize the control object of the target user, such as the palm, in the target image area.

In some embodiments, before the flight control device 11 controls the aircraft 12 to take off, when the flight control device 11 recognizes the control object of the target user based on the environment image, if the flight control device 11 detects that the status parameter of the target user satisfies a second predetermined condition, the flight control device 11 may determine that the characteristic part of the target user is a second characteristic part. Based on the second characteristic part of the target user, the flight control device 11 may determine a target image area in which the second characteristic part is located, and recognize the control object of the target user in the target image area. In some embodiments, the status parameter of the target user may include a proportion of the size of image area where the target user is located in the environment image (e.g., relative to the size of the environment image). The second predetermined condition that the status parameter of the target user may satisfy may include: the proportion of the size of the image area in which the target user is located in the environment image is greater than or equal to the second predetermined value. In some embodiments, the status parameter of the target user may include a distance between the target user and the aircraft. The second predetermined condition that the status parameter of the target user may satisfy may include: the distance between the target user and the aircraft is smaller than or equal to a second predetermined distance. In some embodiments, the second characteristic part may include a head of the target user, or the second characteristic part may include a head, a shoulder, and other body parts of the target user. The present disclosure does not limit the second characteristic part. For example, assuming the second predetermined value is ⅓, and the second characteristic part is the head of the target user, if the flight control device detects that in the environment image captured by the imaging device, the proportion of the size of the image area where the target user is located in the environment image is greater than ⅓, the flight control device may determine that the characteristic part of the target user is the head. The flight control device may determine the target image area in which the head is located based on the head of the target user, thereby recognizing that the control object of the target user in the target image area is the palm.

In some embodiments, when the flight control device 11 recognizes the control object of the target user prior to the takeoff of the aircraft 12, if the flight control device recognizes at least one control object in the target image area, then based on the characteristic part of the target user, the flight control device may determine joints of the target user. Based on the joints of the target user, the flight control device may determine the control object of the target user from the at least one control object. The joints of the target user may include a joint of the characteristic part of the target user. The present disclosure does not limit the joints.

In some embodiments, when the flight control device 11 determines the control object of the target user from the at least one control object, the flight control device may determine a target joint from the joints. The flight control device may determine a control object among the at least one control object that is closest to the target joint as the control object of the target user. In some embodiments, the target joint may include a joint of a specified arm, such as any one or more of an elbow joint of the arm, a joint between the arm and the shoulder, and a wrist joint. The target joint and a finger of the control object belong to the same target user. For example, if the flight control device 11 recognizes two palms (control objects) in the target image area, the flight control device 11 may determine the joint between the arm and the shoulder of the target user, and determine one of the two palms that is the closest to the joint between the arm and the shoulder of the target user as the control object of the target user.

In some embodiments, during the flight after the aircraft 12 takes off, the flight control device 11 may recognize a flight control hand gesture of the control object. If the flight control device 11 recognizes that the flight control hand gesture of the control object is a height control hand gesture, the flight control device 11 may generate a height control command to control the aircraft 12 to adjust the flight height. In some embodiments, during the flight of the aircraft 12, the flight control device 11 may control the imaging device 123 to capture a set of images. The flight control device 11 may perform a motion recognition of the control object based on images included in the set of images to obtain motion information of the control object. The motion information may include information such as a moving direction of the control object. The flight control device 11 may analyze the motion information to obtain the flight control hand gesture of the control object. If the flight control hand gesture is a height control hand gesture, the flight control device 11 may obtain a height control command corresponding to the height control hand gesture, and control the aircraft 12 to fly in the moving direction based on the height control command, thereby adjusting the height of the aircraft 12.

FIG. 1B is a schematic illustration of flight control of an aircraft. The schematic illustration of FIG. 1B includes a target user 13 and an aircraft 12. The target user 13 may include a control object 131. The aircraft 12 has been described above in connection with FIG. 1a. The aircraft 12 may include the propulsion system 121, the gimbal 122, and the imaging device 123. The detailed descriptions of the aircraft 12 can refer to the above descriptions of aircraft 12 in connection with FIG. 1a. In some embodiments, the aircraft 12 may be provided with a flight control device. Assuming that the control object 131 is a palm, during the flight of the aircraft 12, the flight control device may control the imaging device 123 to capture an environment image, and may recognize the palm 131 of the target user 13 from the environment image. If the flight control device recognizes that the hand gesture of the palm 131 of the target user 13 is facing the imaging device 123 and moving upwardly or downwardly in a direction perpendicular to the ground, the flight control device may determine that the hand gesture of the palm is a height control hand gesture. If the flight control device detects that the palm 131 is moving upwardly in a direction perpendicular to the ground, the flight control device may generate a height control command, and control the aircraft 12 to fly in an upward direction perpendicular to the ground, thereby increasing the flight height of the aircraft 12.

In some embodiments, during the flight of the aircraft 12, if the flight control device 11 recognizes that the flight control hand gesture of the control object is a moving control hand gesture, the flight control device may generate a moving control command to control the aircraft to fly in a direction indicated by the moving control command. In some embodiments, the direction indicated by the moving control command may include: a direction moving away from the control object or a direction moving closer to the control object. In some embodiments, if the set of images captured by the imaging device 123 that is controlled by the flight control device 11 include two control objects, a first control object and a second control object, the flight control device 11 may perform motion recognition on the first control object and the second control object to obtain motion information of the first control object and the second control object. Based on the motion information, the flight control device may obtain action characteristics of the first control object and the second control object. The action characteristics may be used to indicate the change in the distance between the first control object and the second control object. The flight control device 11 may obtain a moving control command corresponding to the action characteristics based on the change in the distance.

In some embodiments, if the action characteristics indicate that the change in the distance between the first control object and the second control object is an increase in the distance, then the moving control command may be configured for controlling the aircraft to fly in a direction moving away from the target user. If the action characteristics indicate that the change in the distance between the first control object and the second control object is a decrease in the distance, then the moving control command may be configured for controlling the aircraft to fly in a direction moving closer to the target user.

For illustration purposes, it is assumed that the control object includes the first control object and the second control object, the first control object is the left palm of a human, and the second control object is the right palm of the human. If the flight control device 11 detects that the target user raised the two palms facing the imaging device of the aircraft 12, and detects that the two palms are making an “open the door” action, i.e., the horizontal distance between the two palms is gradually increasing, then the flight control device 11 may determine that the flight control hand gesture of the two palms is a moving control hand gesture. The flight control device 11 may generate a moving control command to control the aircraft 12 to fly in a direction moving away from the target user. As another example, if flight control device 11 detects that the two palms are making a “close the door” action, i.e., the horizontal distance between the two palms is gradually decreasing, then the flight control device may determine that the flight control hand gesture of the two palms is a moving control hand gesture. The flight control device 11 may generate a moving control command to control the aircraft 12 to fly in a direction moving closer to the target user.

In some embodiments, during the flight of the aircraft 12, if the flight control device 11 recognizes that the flight control hand gesture of the control object is a drag control hand gesture, the flight control device 11 may generate a drag control command to control the aircraft to fly in a horizontal direction indicated by the towing control command. In some embodiments, the drag control hand gesture may be a palm of the target user dragging to the left or to the right in a horizontal direction. For example, if the flight control device 11 recognizes that the palm of the target user is dragging to the left horizontally, the flight control device 11 may generate a drag control command to control the aircraft to fly to the left in a horizontal direction.

In some embodiments, during the flight of the aircraft 12, if the flight control device 11 recognizes that the flight control hand gesture of the control object is a rotation control hand gesture, the flight control device may generate a rotation control command to control the aircraft to fly around the target user in a direction indicated by the rotation control command. In some embodiments, the rotation control hand gesture may be the palm of the target user rotating using the target user as a center. For example, the flight control device 11 may recognize the movement of the palm of the control object and the target user based on the images included in the set of images captures by the imaging device 123. The flight control device 11 may obtain motion information relating to the palm and the target user. The motion information may include a moving direction of the palm and the target user. Based on the motion information, if the flight control device 11 determines that the palm and the target user are rotating using the target user as a center, then the flight control device may generate a rotation control command to control the aircraft to fly around the target user in a direction indicated by the rotation control command. For example, if the flight control device 11 detects that the target user and the palm of the target user are rotating clockwise using the target user as a center, the flight control device 11 may generate a rotation control command to control the aircraft 12 to rotate clockwise using the target user as a center.

In some embodiments, during the flight of the aircraft 12, if the flight control device 11 recognizes that the flight control hand gesture of the control object is a landing hand gesture, the flight control device may generate a landing control command to control the aircraft to land. In some embodiments, the landing hand gesture may include the palm of the target user moving downwardly while facing the ground. In some embodiments, the landing hand gesture may include other hand gesture of the target user. The present disclosure does not limit the landing hand gesture. In some embodiments, during the flight of the aircraft 12, if the flight control device 11 recognizes that the palm of the target user is making a downward moving hand gesture while facing the ground, the flight control device may generate a landing control command to control the aircraft to land to a target location. The target location may be a pre-set location, or may be determined based on the height of the aircraft 12 above the ground as detected by the aircraft. The present disclosure does not limit the target location. If the flight control device detects that the landing hand gesture stays at the target location for more than a predetermined time period, the flight control device may control the aircraft 12 to land to the ground. For illustration purposes, it is assumed that the predetermined time period is 3 s (3 seconds), and the target location as determined based on the height of the aircraft above the ground detected by the aircraft is 0.5 m (0.5 meter) above the ground. Then, during the flight of the aircraft 12, if the flight control device 11 recognizes that the palm of the target user is making a downward moving hand gesture while facing the ground, the flight control device may generate a landing control command to control the aircraft 12 to land to a location 0.5 m above the ground. If the flight control device detects that the hand gesture that moves downwardly while facing the ground, made by the palm of the target user, stays at the location 0.5 m above the ground for more than 3 s, the flight control device may control the aircraft 12 to land to the ground.

In some embodiments, during the flight of the aircraft 12, if the flight control device does not recognize the flight control hand gesture of the target user, and if the flight control device recognizes the characteristic part of the target user from the flight environment image, then the flight control device may control the aircraft based on the characteristic part of the target user to use the target user as a tracking target, and to follow the movement of the target user. The characteristic part of the target user may be any body region of the target user. The present disclosure does not limit the characteristic part. In some embodiments, the aircraft following the movement of the target user may include: adjusting at least one of a location of the aircraft, an attitude of the gimbal carried by the aircraft, or an attitude of the aircraft to follow the target user as the target user moves, such that the target user is included in the images captured by the imaging device. In some embodiments, during the flight of the aircraft 12, if the flight control device 11 does not recognize the flight control hand gesture of the target user, and the flight control device recognizes a first body region of the target user in the flight environment image, then the flight control device may control the aircraft based on the first body region to use the target user as a tracking target. The flight control device may control the aircraft to follow the movement of the first body region, and to adjust at least one of a location of the aircraft, an attitude of the gimbal carried by the aircraft, or an attitude of the aircraft while following the movement of the first body region, such that the target user is included in the images captured by the imaging device.

In some embodiments, during the flight of the aircraft 12, if the flight control device 11 does not recognize the hand gesture made by the palm of the target user, and if the flight control device recognizes the body region where the main body of the target user is located, then the flight control device 11 may control the aircraft to use the target user as a tracking target based on the body region where the main body is located. The flight control device may control the aircraft to follow the movement of the body region where the main body is located, and to adjust at least one of a location of the aircraft, an attitude of the gimbal carried by the aircraft, or an attitude of the aircraft while following the movement of the body region where the main body is located, such that the target user is included in the images captured by the imaging device.

In some embodiments, during the flight of the aircraft 12, if the flight control device 11 does not recognize the flight control hand gesture of the target user, and does not detect the first body region of the target user, but recognizes a second body region of the target user, then during the flight of the aircraft 12, the flight control device 11 may control the aircraft 12 to follow the movement of the second body region. In some embodiments, during the flight of the aircraft 12, if the flight control device 11 does not recognize the hand gesture of the target user, and does not detect the first body region of the target user, but detects the second body region of the target user, then during the flight of the aircraft 12, the flight control device 11 may control the aircraft to use the target user as a tracking target based on the second body region. The flight control device may control the aircraft to follow the second body region as the second body region moves, and to adjust at least one of a location of the aircraft, an attitude of the gimbal carried by the aircraft, or an attitude of the aircraft while following the movement of the second body region, such that the target user is included in the images captured by the imaging device.

In some embodiments, during the flight of the aircraft 12, if the flight control device 11 does not recognize the hand gesture made by the palm of the target user, and does not recognize the body region where the main body of the target user is located, but recognizes the body region where the head of the target user is located, then the flight control device 11 may control the aircraft to use the target user as a tracking target based on the body region where the head and shoulder are located. The flight control device 11 may control the aircraft to follow the movement of the body region where the head and shoulder are located, and to adjust at least one of a location of the aircraft, an attitude of the gimbal carried by the aircraft, or an attitude of the aircraft while following the movement of body region where the head and shoulder are located, such that the target user is included in the images captured by the imaging device.

In some embodiments, if the flight control device 11 recognizes that the flight control hand gesture of the target user is a photographing hand gesture, then the flight control device 11 may generate a photographing control command to control the imaging device of the aircraft to capture a target image. The photographing hand gesture may be any suitable hand gesture, such as an “0” hand gesture. The present disclosure does not limit the photographing hand gesture. For example, if the photographing hand gesture is the “0” hand gesture, and if the flight control device 11 recognizes that the hand gesture of the palm of the target user is an “0” hand gesture, then the flight control device may generate a photographing control command to control the imaging device of the aircraft to capture the target image.

In some embodiments, if the flight control device 11 recognizes the flight control hand gesture of the control object to be a video-recording hand gesture, then the flight control device 11 may generate a video-recording control command to control the imaging device of the aircraft to capture videos. While the imaging device of the aircraft captures the videos, if the flight control device 11 again recognizes the video-recording hand gesture of the control object, the flight control device 11 may generate an ending control command to control the imaging device of the aircraft to end the video recording. The video-recording hand gesture may be any suitable hand gesture, which the present disclosure does not limit. For example, assuming the video-recording hand gesture is a “1” hand gesture, if the flight control device 11 recognizes that the hand gesture made by the palm of the target user is a “1” hand gesture, the flight control device 11 may generate a video-recording control command to control the imaging device of the aircraft to capture videos. While the imaging device of the aircraft captures videos, if the flight control device 11 again recognizes the “1” hand gesture made by the target user, the flight control device 11 may generate an ending control command to control the imaging device of the aircraft to end the video recording.

In some embodiments, if the flight control device 11 does not recognize the flight control hand gesture of the control object of the target user, but recognizes a replacement control hand gesture of a control object of a replacement user, then the target user may be replaced by the replacement user (hence the replacement user becomes the new target user). The flight control device 11 may recognize the control object of the new target user and the replacement control hand gesture. The flight control device 11 may generate a control command based on the replacement control hand gesture to control the aircraft to perform an action corresponding to the control command. The replacement control hand gesture may be any suitable hand gesture, which the present disclosure does not limit. In some embodiments, if the flight control device 11 does not recognize the flight control hand gesture of a target user, but recognizes that the replacement control hand gesture made by a replacement user is an “0” hand gesture, while the replacement user is facing the imaging device of the aircraft 12, then the flight control device 11 may replace the target user by the replacement user. The flight control device 11 may generate a photographing control command based on the “0” hand gesture of the replacement user to control the imaging device of the aircraft to capture a target image.

Next, the flight control method of the aircraft is explained with reference to the drawings of the present disclosure.

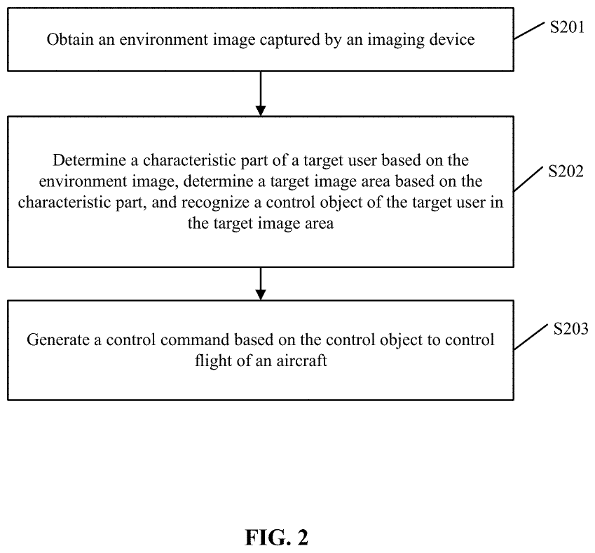

FIG. 2 is a flow chart illustrating a flight control method. The method of FIG. 2 may be executed by the flight control device. The flight control device may be provided on the aircraft. The aircraft may carry an imaging device. The detailed descriptions of the flight control device can refer to the above descriptions. The method of FIG. 2 may include:

Step S201: obtaining an environment image captured by an imaging device.

In some embodiments, the flight control device may obtain the environment image captured by the imaging device carried by the aircraft.

Step S202: determining a characteristic part of a target user based on the environment image, determining a target image area based on the characteristic part, and recognizing a control object of the target user in the target image area.

In some embodiments, the flight control device may determine the characteristic part of the target user based on the environment image, determine the target image area based on the characteristic part, and recognize the control object of the target user in the target image area. The control object may include, but is not limited to, the palm of the target user.

In some embodiments, when the flight control device determines the characteristic part of the target user based on the environment image, determines the target image area based on the characteristic part, and recognizes the control object of the target user in the target image area, if a status parameter of the target user satisfies a first predetermined condition, the flight control device may determine the characteristic part of the target user as a first characteristic part. Based on the first characteristic part of the target user, the flight control device may determine the target image area in which the first characteristic part is located, and recognize the control object of the target user in the target image area. In some embodiments, the status parameter of the target user may include a proportion of a size of an image area in which the target user is located in the environment image (e.g., relative to the size of the environment image). The first predetermined condition that the status parameter of the target user may satisfy may include: the proportion of the size of the image area in which the target user is located in the environment image is smaller than or equal to a first predetermined proportion value. In some embodiments, the status parameter of the target user may include a distance between the target user and the aircraft. The first predetermined condition that the status parameter of the target user may satisfy may include: the distance between the target user and the aircraft is greater than or equal to a first predetermined distance. In some embodiments, the first characteristic part may include, but not be limited to, a human body of the target user. For example, assuming the first predetermined proportion value is ⅓, and the first characteristic part is the human body of the target user, if the flight control device detects that in the environment image captured by the imaging device, the proportion of the size of the image area where the target user is located in the environment image is smaller than ⅓, then the flight control device may determine that the characteristic part of the target user is the human body. The flight control device may determine the target image area in which the human body is located based on the human body of the target user. The flight control device may recognize the control object of the target user, such as the palm, in the target image area.

In some embodiments, if the status parameter of the target user satisfies a second predetermined condition, the flight control device 11 may determine that the characteristic part of the target user is a second characteristic part. Based on the second characteristic part of the target user, the flight control device 11 may determine a target image area in which the second characteristic part is located, and recognize the control object of the target user in the target image area. The second predetermined condition that the status parameter of the target user may satisfy may include: the proportion of the size of the image area in which the target user is located in the environment image is greater than or equal to the second predetermined value. In some embodiments, the status parameter of the target user may include a distance between the target user and the aircraft. The second predetermined condition that the status parameter of the target user may satisfy may include: the distance between the target user and the aircraft is smaller than or equal to a second predetermined distance. In some embodiments, the second characteristic part may include a head of the target user, or the second characteristic part may include a head, a shoulder, and other body parts of the target user. The present disclosure does not limit the second characteristic part. For example, assuming the second predetermined value is ½, and the second characteristic part is the head of the target user, if the flight control device detects that in the environment image captured by the imaging device, the proportion of the size of the image area where the target user is located in the environment image is greater than ½, the flight control device may determine that the characteristic part of the target user is the head. The flight control device may determine the target image area in which the head is located based on the head of the target user, and may recognize that the control object of the target user in the target image area is the palm.

In some embodiments, when the flight control device 11 recognizes the control object of the target user in the target image area, if the flight control device recognizes at least one control object in the target image area, then based on the characteristic part of the target user, the flight control device may determine joints of the target user. Based on the joints of the target user, the flight control device may determine the control object of the target user from the at least one control object.

In some embodiments, when the flight control device 11 determines the control object of the target user from the at least one control object based on the joints, the flight control device may determine a target joint from the joints. The flight control device may determine a control object among the at least one control object that is closest to the target joint as the control object of the target user. In some embodiments, the target joint may include a joint of a specified arm, such as any one or more of an elbow joint of the arm, a joint between the arm and the shoulder, and a wrist joint. The target joint and a finger of the control object may belong to the same target user. For example, if the target image area determined by the flight control device is a target image area in which the body of the target user is located, and if the flight control device recognizes two palms (control objects) in the target image area, the flight control device 11 may determine the joint between the arm and the shoulder of the target user, and determine one of the two palms that is the closest to the joint between the arm and the shoulder of the target user as the control object of the target user.

Step S203: generating a control command based on the control object to control flight of an aircraft.

In some embodiments, the flight control device may generate a control command based on the control object to control the flight of the aircraft. In some embodiments, the flight control device may recognize action characteristics of the control object, obtain the control command based on the action characteristics of the control object, and control the aircraft based on the control command.

In some embodiments, flight control device may obtain an environment image captured by an imaging device. The flight control device may determine a characteristic part of a target user, and determine a target image area based on the characteristic part. The flight control device may recognize or identify a control object of the target user in the target image area, thereby generating a control command based on the control object to control the flight of the aircraft. Through the disclosed methods, the control object of the target user is recognized, and the flight of the aircraft can be controlled based on recognition of the action characteristics of the control object. Fast control of the aircraft can be achieved, and the flight control efficiency can be increased.

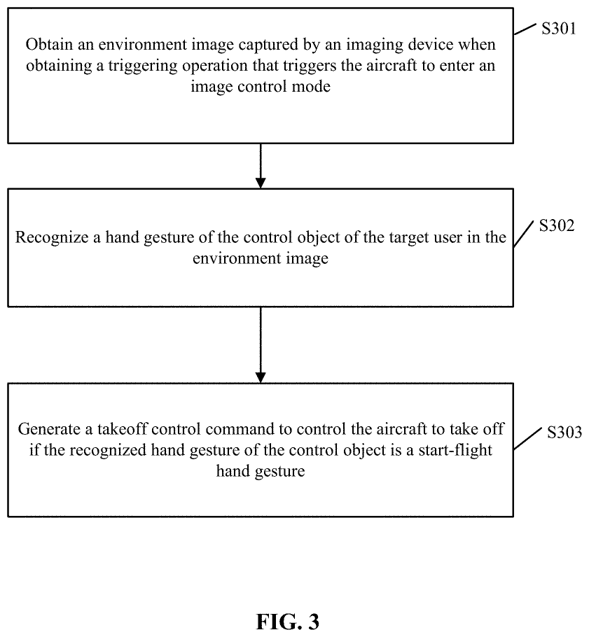

FIG. 3 is a flow chart illustration another flight control method that may be executed by the flight control device. The detailed descriptions of the flight control device may refer to the above descriptions. The embodiment shown in FIG. 3 differs from the embodiment shown in FIG. 2 in that the method of FIG. 3 includes triggering the aircraft to enter an image control mode based on an obtained triggering operation, and recognizing the hand gesture of the control object of the target user in the image control mode. In addition, the method of FIG. 3 includes generating a takeoff control command based on a recognized start-flight hand gesture to control the aircraft to take off.

Step S301: obtaining an environment image captured by an imaging device when obtaining a triggering operation that triggers the aircraft to enter an image control mode.

In some embodiments, if the flight control device obtains a triggering operation that triggers the aircraft to enter an image control mode, the flight control device may obtain an environment image captured by the imaging device. The environment image may be a preview image captured by the imaging device before the aircraft takes off. In some embodiments, the triggering operation may include one or more of: a point-click operation on a power button of the aircraft, a double-click operation of the power button of the aircraft, a shaking operation of the aircraft, a voice input operation, and a fingerprint input operation. The triggering operation may also include one or more of a scanning operation of a characteristic object, an interactive operation of a smart accessory (e.g., smart eye glasses, a smart watch, a smart band, etc.). The present disclosure does not limit the triggering operation. For example, if the triggering operation is the double-click of the power button of the aircraft, and if the flight control device detects the double-click operation on the power button of the aircraft performed by the target user, the flight control device may trigger the aircraft to enter the image control mode, and obtain an environment image captured by the imaging device carried by the aircraft.

Step S302: recognizing a hand gesture of the control object of the target user in the environment image.

In some embodiments, in the image control mode, the flight control device may recognize a hand gesture of the control object of the target user in the environment image captured by the imaging device of the aircraft. In some embodiments, the target user may be a movable object, such as a human, an animal, or an unmanned vehicle. The control object may be a palm of the target user, or other body parts or body regions, such as he face, the head, or the shoulder. The present disclosure does not limit the target user and the control object.

In some embodiments, when the flight control device obtains the environment image captured by the imaging device, the flight control device may control the gimbal carried by the aircraft to rotate after obtaining the triggering operation, so as to control the imaging device to scan and photograph in a predetermined photographing range. The flight control device may obtain the environment image that includes a characteristic part of the target user, which is obtained by the imaging device by scanning and photographing in the predetermined photographing range.

Step S303: generating a takeoff control command to control the aircraft to take off if the recognized hand gesture of the control object is a start-flight hand gesture.

In some embodiments, if the flight control device recognizes that the hand gesture of the control object is a start-flight hand gesture, the flight control device may generate a takeoff control command to control the aircraft to take off. In some embodiments, in the image control mode, if the flight control device recognizes that the hand gesture of the control object is a start-flight hand gesture, the flight control device may generate the takeoff control command to control the aircraft to fly to a location corresponding to a target height and hover at the location. The target height may be a pre-set height above the ground, or may be determined based on location or region in which the target user is located in the environment image captured by the imaging device. The present disclosure does not limit the target height that the aircraft hovers after takeoff. In some embodiments, the start-flight hand gesture may be any suitable hand gesture of the target user, such as an “OK” hand gesture, a scissor hand gesture, etc. The present disclosure does not limit the start-flight hand gesture. For example, if the triggering operation is the double-click operation on the power button of the aircraft, the control object is the palm of the target user, the start-flight hand gesture is set as the scissor hand gesture, and the pre-set target height is 1.2 m above the ground, then, if the flight control device detects the double-click operation on the power button of the aircraft performed by the target user, the flight control device may control the aircraft to enter the image control mode. In the image control mode, if the flight control device recognizes the hand gesture of the palm of the target user to be a scissor hand gesture, the flight control device may generate a takeoff control command to control the aircraft to take off and fly to a location having the target height of 1.2 m above the ground, and hover at that location.

In some embodiments, the flight control device may control the aircraft to enter the image control mode by obtaining the triggering operation that triggers the aircraft to enter the image control mode. The flight control device may recognize the hand gesture of the control object of the target user in the environment image obtained from the imaging device. If the flight control device recognizes the hand gesture of the control object to be a start-flight hand gesture, the flight control device may generate a takeoff control command to control the aircraft to take off. Through the disclosed methods, controlling aircraft takeoff through hand gesture recognition may be achieved, thereby realizing fast control of the aircraft. In addition, the efficiency of controlling the takeoff of the aircraft can be increased.

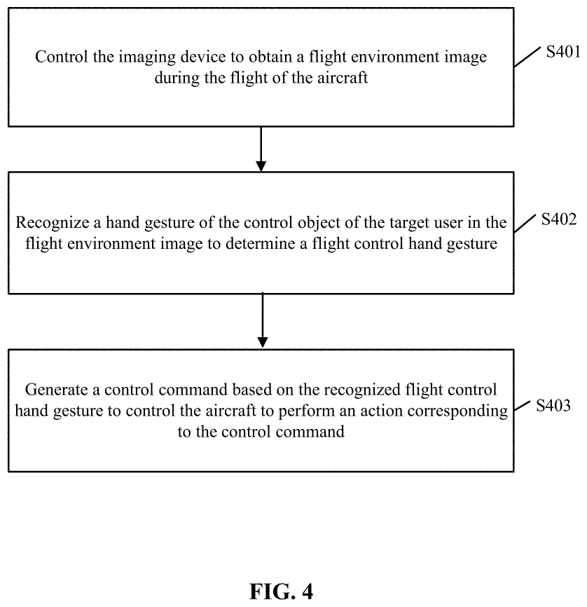

FIG. 4 is a flow chart illustrating another flight control method that may be executed by the flight control device. The detailed descriptions of the flight control device can refer to the above descriptions. The embodiment shown in FIG. 4 differs from the embodiment shown in FIG. 3 in that, the method of FIG. 4 includes, during the flight of the aircraft, recognizing the hand gesture of the control object of the target user and determining the flight control hand gesture. The control command may be generated based on the flight control hand gesture, and the aircraft may be controlled to perform actions corresponding to the control command.

Step S401: controlling the imaging device to obtain a flight environment image during the flight of the aircraft.

In some embodiments, during the flight of the aircraft, the flight control device may control the imaging device carried by the aircraft to capture a flight environment image. The flight environment image refers to an environment image captured by the imaging device of the aircraft during the flight through scanning and photographing.

Step S402: recognizing a hand gesture of the control object of the target user in the flight environment image to determine a flight control hand gesture.

In some embodiments, the flight control device may recognize the hand gesture of the control object of the target user in the flight environment image to determine the flight control hand gesture. The control object may include, but not be limited to, the palm of the target user. The flight control hand gesture may include one or more of a height control hand gesture, a moving control hand gesture, a drag control hand gesture, a rotation control hand gesture, a landing hand gesture, a photographing hand gesture, a video-recording hand gesture, or a replacement control hand gesture. The present disclosure does not limit the flight control hand gesture.

Step S403: generating a control command based on the recognized flight control hand gesture to control the aircraft to perform an action corresponding to the control command.

In some embodiments, the flight control device may recognize the flight control hand gesture, and generate the control command to control the aircraft to perform an action corresponding to the control command.

In some embodiments, during the flight of the aircraft, if the flight control device recognizes that the flight control hand gesture of the control object is a height control hand gesture, the flight control device may generate a flight control command to control the aircraft to adjust the flight height of the aircraft. In some embodiments, the flight control device may recognize the motion of the control object based on the images included in the set of images obtained by the imaging device. The flight control device may obtain motion information, which may include, for example, a moving direction of the control object. The set of images may include multiple environment images captured by the imaging device. The flight control device may analyze the motion information to obtain the flight control hand gesture of the control object. If the flight control hand gesture is a height control hand gesture, the flight control device may generate a height control command corresponding to the height control hand gesture. The flight control device may control the aircraft to fly in the moving direction to adjust the height of the aircraft. For example, as shown in FIG. 1B, during the flight of the aircraft, the flight control device of the aircraft 12 may recognize the palm of the target user in the multiple environment images captured by the imaging device. If the flight control device recognizes that the palm 131 of the target user 13 is moving downwardly in a direction perpendicular to the ground while facing the imaging device, the flight control device may determine that hand gesture of the palm 131 is a height control hand gesture, and may generate the height control command. The flight control device may control the aircraft 12 to fly downwardly in a direction perpendicular to the ground, to reduce the height of the aircraft 12. As another example, if the flight control device detects that the palm 131 is moving upwardly in a direction perpendicular to the ground, the flight control device may generate the height control command to control the aircraft 12 to fly upwardly in a direction perpendicular to the ground, thereby increasing the height of the aircraft 12.

In some embodiments, during the flight of the aircraft, if the flight control device recognizes that the flight control hand gesture of the control object is a moving control hand gesture, the flight control device may generate a moving control command to control the aircraft to fly in a direction indicated by the moving control command. In some embodiments, the direction indicated by the moving control command may include: a direction moving away from the control object or a direction moving closer to the control object. In some embodiments, if the flight control device recognizes motions of a first control object and a second control object included in the control object based on the images included in the set of images, the flight control device may obtain the motion information of the first control object and the second control object. The set of images may include multiple environment images captured by the imaging device. Based on the motion information, the flight control device may obtain the action characteristics of the first control object and the second control object. In some embodiments, the action characteristics may indicate a change in the distance between the first control object and the second control object. The flight control device may generate the moving control command corresponding to the action characteristics based on the change in the distance.

In some embodiments, if the action characteristics indicate that the change in the distance between the first control object and the second control object is an increase in the distance, the moving control command may be configured to control the aircraft to fly in a direction moving away from the target user. If the action characteristics indicate that the change in the distance between the first control object and the second control object is a decrease in the distance, the moving control command may be configured to control the aircraft to fly in a direction moving closer to the target user. For example, assuming that the control object includes the first control object and the second control object, the first control object is the left palm of the target user, and the second control object is the right palm of the target user, if the flight control device detects the two palms raised by the target user while facing the imaging device of the aircraft, and if the flight control device detects that the distance between the two palms in the horizontal direction is gradually increasing, then the flight control device may determine that the flight control hand gesture made by the two palms is a moving control hand gesture. The flight control device may generate a moving control command to control the aircraft to fly in a direction moving away from the target user. As another example, if the flight control device detects that the distance between the two palms in the horizontal direction is gradually decreasing, the flight control device may determine that the flight control hand gesture made by the two palms is a moving control hand gesture. The flight control device may generate a moving control command to control the aircraft to fly in a direction moving closer to the target user.

In some embodiments, during the flight of the aircraft, if the flight control device recognizes that the flight control hand gesture of the control object is a drag control hand gesture, the flight control device may generate a drag control command to control the aircraft to fly in a horizontal direction indicated by the drag control command. For example, the drag control hand gesture may be the palm of the target user dragging to the left or to the right horizontally. If the flight control device recognizes that the palm of the target user drags to the left horizontally, the flight control device may generate a drag control command to control the aircraft to fly to the left horizontally.

In some embodiments, during the flight of the aircraft, if the flight control device recognizes that the flight control hand gesture of the control object is a rotation control hand gesture, the flight control device may generate a rotation control command to control the aircraft to fly around the target user in a direction indicated by the rotation control command. In some embodiments, the rotation control hand gesture refers to the palm of the target user rotating using the target user as a center. In some embodiments, based on images included in the set of images, the flight control device may recognize the motions of the palm of the control object and the target user to obtain motion information of the palm and the target user. The motion information may include a moving direction of the palm and the target user. The set of images may include multiple environment images captured by the imaging device. Based on the motion information, the flight control device may determine that the palm and the target user are rotating using the target user as a center. The flight control device may generate a rotation control command to control the aircraft to fly around the target user in a direction indicated by the rotation control command. For example, if the flight control device detects that the palm and the target user are rotating counter-clockwise using the target user as a center, the flight control device may generate a rotation control command to control the aircraft to rotate counter-clockwise using the target user as a center.

In some embodiments, during the flight of the aircraft, if the flight control device recognizes that the flight control hand gesture of the control object is a landing hand gesture, the flight control device may generate a landing control command to control the aircraft to land.

In some embodiments, the landing hand gesture may include the palm of the target user moving downward while facing the ground. In some embodiments, the landing hand gesture may include other hand gesture of the target user. The present disclosure does not limit the landing hand gesture. In some embodiments, during the flight of the aircraft, if the flight control device recognizes that the palm of the target user is making a downward moving hand gesture while facing the ground, the flight control device may generate a landing control command to control the aircraft to land to a target location. The target location may be a pre-set location, or may be determined based on the height of the aircraft above the ground detected by the aircraft. The present disclosure does not limit the target location. If the flight control device detects that the landing hand gesture stays at the target location for more than a predetermined time period, the flight control device may control the aircraft to land to the ground. For illustration purposes, it is assumed that the predetermined time period is 3 s (3 seconds), and the target location as determined based on the height of the aircraft above the ground detected by the aircraft is 0.5 m above the ground. Then, during the flight of the aircraft, if the flight control device recognizes that the palm of the target user is making a downwardly moving hand gesture while facing the ground, the flight control device may generate a landing control command to control the aircraft to land to a location 0.5 m above the ground. If the flight control device detects that the hand gesture that moves downwardly while facing the ground, made by the palm of the target user, stays at the location 0.5 m above the ground for more than 3 s, the flight control device may control the aircraft to land to the ground.

In some embodiments, during the flight of the aircraft, if the flight control device does not recognize the flight control hand gesture of the target user, and if the flight control device recognizes the characteristic part of the target user from the flight environment image, then the flight control device may control the aircraft based on the characteristic part of the target user to use the target user as a tracking target, and to follow the movement of the target user. The characteristic part of the target user may be any body region of the target user. In some embodiments, the aircraft following the movement of the target user may include: adjusting at least one of a location of the aircraft, an attitude of the gimbal carried by the aircraft, or an attitude of the aircraft to follow the target user as the target user moves, such that the target user is included in the images captured by the imaging device. In some embodiments, during the flight of the aircraft, if the flight control device does not recognize the flight control hand gesture of the target user, and the flight control device recognizes a first body region of the target user in the flight environment image, then the flight control device may control the aircraft based on the first body region to use the target user as a tracking target. The flight control device may control the aircraft to follow the movement of the first body region, and to adjust at least one of a location of the aircraft, an attitude of the gimbal carried by the aircraft, or an attitude of the aircraft while following the movement of the first body region, such that the target user is included in the images captured by the imaging device.

In some embodiments, during the flight of the aircraft, if the flight control device does not recognize the hand gesture made by the palm of the target user, and if the flight control device recognizes the body region where the main body of the target user is located, then the flight control device may control the aircraft to use the target user as a tracking target based on the body region where the main body is located. The flight control device may control the aircraft to follow the movement of the body region where the main body is located, and to adjust at least one of a location of the aircraft, an attitude of the gimbal carried by the aircraft, or an attitude of the aircraft while following the movement of the body region where the main body is located, such that the target user is included in the images captured by the imaging device.

In some embodiments, during the flight of the aircraft, if the flight control device does not recognize the flight control hand gesture of the target user, and does not detect the first body region of the target user, but recognizes a second body region of the target user, then during the flight of the aircraft, the flight control device may control the aircraft to follow the movement of the second body region. In some embodiments, during the flight of the aircraft, if the flight control device does not recognize the hand gesture and does not detect the first body region of the target user, but detects the second body region of the target user, then during the flight of the aircraft, the flight control device may control the aircraft to use the target user as a tracking target based on the second body region. The flight control device may control the aircraft to follow the second body region as the second body region moves, and to adjust at least one of a location of the aircraft, an attitude of the gimbal carried by the aircraft, or an attitude of the aircraft while following the movement of the second body region, such that the target user is included in the images captured by the imaging device.

In some embodiments, during the flight of the aircraft, if the flight control device does not recognize the hand gesture made by the palm of the target user, and does not recognize the body region where the main body of the target user is located, but recognizes the body region where the head of the target user is located, then the flight control device may control the aircraft to use the target user as a tracking target based on the body region where the head and shoulder are located. The flight control device may control the aircraft to follow the movement of the body region where the head and shoulder are located, and to adjust at least one of a location of the aircraft, an attitude of the gimbal carried by the aircraft, or an attitude of the aircraft while following the movement of body region where the head and shoulder are located, such that the target user is included in the images captured by the imaging device.

In some embodiments, while the aircraft follows the movement of the target user, the flight control device may recognize a characteristic part of the target user to obtain an image size of the characteristic part in the image. Based on the image size, the flight control device may generate a control command to control the aircraft to move in a direction indicated in the control command. For example, if the characteristic part is the body of the target user, and if the flight control device detects that the body of the target user is moving forward, and the image size of the body of the target user is increasing in the captured image, the flight control device may control the aircraft to move in a direction moving away from the target user.

In some embodiments, if the flight control device recognizes that the flight control hand gesture of the target user is a photographing hand gesture, then the flight control device may generate a photographing control command to control the imaging device of the aircraft to capture a target image. The photographing hand gesture may be any suitable hand gesture, such as an “0” hand gesture. The present disclosure does not limit the photographing hand gesture. For example, if the photographing hand gesture is the “0” hand gesture, and if the flight control device recognizes that the hand gesture of the palm of the target user is an “0” hand gesture, then the flight control device may generate a photographing control command to control the imaging device of the aircraft to capture the target image.

In some embodiments, if the flight control device recognizes the flight control hand gesture of the control object to be a video-recording hand gesture, then the flight control device may generate a video-recording control command to control the imaging device of the aircraft to capture videos. While the imaging device of the aircraft captures the videos, if the flight control device again recognizes the video-recording hand gesture of the control object, the flight control device may generate an ending control command to control the imaging device of the aircraft to end the video recording. The video-recording hand gesture may be any suitable hand gesture, which the present disclosure does not limit. For example, assuming the video-recording hand gesture is a “1” hand gesture, if the flight control device recognizes that the hand gesture made by the palm of the target user is a “1” hand gesture, the flight control device may generate a video-recording control command to control the imaging device of the aircraft to capture videos. While the imaging device of the aircraft captures videos, if the flight control device again recognizes the “1” hand gesture made by the target user, the flight control device may generate an ending control command to control the imaging device of the aircraft to end the video recording.

In some embodiments, if the flight control device does not recognize the flight control hand gesture of the control object of the target user, but recognizes a replacement control hand gesture of a control object of a replacement user, then the target user may be replaced by the replacement user (hence the replacement user becomes the new target user). The flight control device may recognize the control object of the new target user and the replacement control hand gesture. The flight control device may generate a control command based on the replacement control hand gesture to control the aircraft to perform an action corresponding to the control command. The replacement control hand gesture may be any suitable hand gesture, which the present disclosure does not limit. In some embodiments, if the flight control device does not recognize the flight control hand gesture of a target user, but recognizes that the replacement control hand gesture made by a replacement user is an “0” hand gesture, while the replacement user is facing the imaging device of the aircraft, then the flight control device may replace the target user by the replacement user. The flight control device may generate a photographing control command based on the “0” hand gesture of the replacement user to control the imaging device of the aircraft to capture a target image.

In some embodiments, during the flight of the aircraft, the flight control device may control the imaging device to obtain a flight environment image. The flight control device may recognize a hand gesture of the control object of the target user in the flight environment image to determine a flight control hand gesture. Based on the flight control hand gesture, the flight control device may generate a control command to control the aircraft to perform an action corresponding to the control command. Through the disclosed methods, the aircraft may be controlled to perform an action indicated by a hand gesture recognized through a hand gesture recognition process, thereby simplifying the operations of controlling the aircraft. Accordingly, fast control of the aircraft can be achieved, and the aircraft control efficiency can be increased.

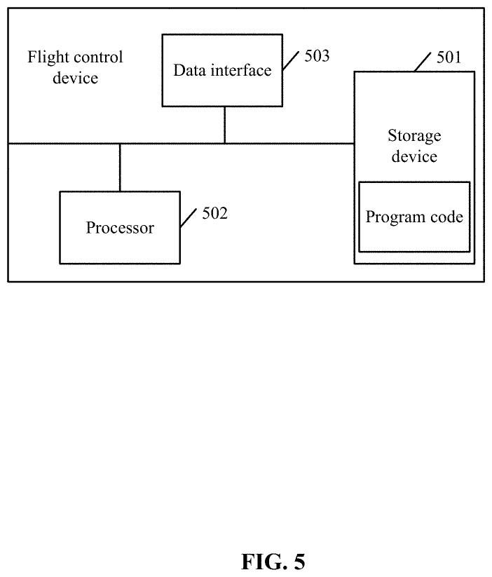

FIG. 5 is a schematic diagram of a flight control device. The flight control device may include a storage device 501, a processor 502, and a data interface 503.

In some embodiments, the storage device 501 may include at least one of a volatile memory and a non-volatile memory. In some embodiments, the storage device 501 may include a combination of a volatile memory and a non-volatile memory. The processor 502 may include a central processing unit. The processor 502 may also include a hardware chip. The hardware chip may include at least one of an application-specific integrated circuit (“ASIC”), a programmable logic device (“PLD”), or a combination thereof. The hardware chip may include a complex programmable logic device (“CPLD”), a field-programmable gate array (“FPGA”), or any combination thereof.

In some embodiments, the storage device 501 may be configured to store program code or instructions. When the program code is executed by the processor 502, the processor 502 may retrieve or read the program code stored in the storage device 501, and execute the program code to perform processes including:
obtaining an environment image captured by an imaging device;
determining a characteristic part of a target user based on the environment image, determining a target image area based on the characteristic part, and recognizing a control object of the target user in the target image area; and
generating a control command based on the control object to control the flight of the aircraft.

In some embodiments, the processor 502 may retrieve the program code stored in the storage device 501 to perform processes including:
recognizing an action characteristic of the control object, and obtaining a control command based on the action characteristic of the control object; and
controlling the flight of the aircraft based on the control command.

In some embodiments, the control object may include the palm of the target user.

In some embodiments, the processor 502 may retrieve the program code stored in the storage device 501 to perform processes including:
determining that the characteristic part of the target user is a first characteristic part when a status parameter of the target user satisfies a first predetermined condition; and
determining a target image area in which the first characteristic part is located based on the first characteristic part of the target user, and recognizing the control object of the target user in the target image area.

In some embodiments, the status parameter of the target user may include a proportion of a size of an image area in which the target user is located in the environment image (e.g., relative to the size of the environment image); the first predetermined condition that the status parameter of the target user may satisfy may include: the proportion of the size of the image area in which the target user is located in the environment image is smaller than or equal to a first predetermined proportion value; or

the status parameter of the target user may include a distance between the target user and the aircraft; the first predetermined condition that the status parameter of the target user may satisfy may include: the distance between the target user and the aircraft is greater than or equal to a first predetermined distance.

In some embodiments, the first characteristic part includes a human body of the target user.

In some embodiments, the processor 502 may retrieve the program code stored in the storage device 501 to perform processes including:
if the status parameter of the target user satisfies a second predetermined condition, determining that the characteristic part of the target user is a second characteristic part; and
based on the second characteristic part of the target user, determining a target image area in which the second characteristic part is located, and recognizing the control object of the target user in the target image area.

In some embodiments, the status parameter of the target user may include a proportion of the size of the image area where the target user is located in the environment image (e.g., relative to the size of the environment image); the second predetermined condition that the status parameter of the target user may satisfy may include: the proportion of the size of the image area in which the target user is located in the environment image is greater than or equal to the second predetermined value; or
the status parameter of the target user may include a distance between the target user and the aircraft; the second predetermined condition that the status parameter of the target user may satisfy may include: the distance between the target user and the aircraft is smaller than or equal to a second predetermined distance.

In some embodiments, the second characteristic part may include a head of the target user, or the second characteristic part may include a head and a shoulder.

In some embodiments, the processor 502 may retrieve the program code stored in the storage device 501 to perform processes including:
recognizing at least one control object in the target image area;
based on the characteristic part of the target user, determining joints of the target user; and
based on the determined joints, determining the control object of the target user from the at least one control object.

In some embodiments, the processor 502 may retrieve the program code stored in the storage device 501 to perform processes including:
determining a target joint from the determined joints; and
determining that a control object in the at least one control object that is closest to the target joint as the control object of the target user.

In some embodiments, flight control device may obtain an environment image captured by an imaging device. The flight control device may determine a characteristic part of a target user, and determine a target image area based on the characteristic part. The flight control device may recognize or identify a control object of the target user in the target image area, thereby generating a control command based on the control object to control the flight of the aircraft. Through the disclosed methods, the control object of the target user is recognized, and the flight of the aircraft can be controlled based on recognition of the action characteristics of the control object. Fast control of the aircraft can be achieved, and the flight control efficiency can be increased.

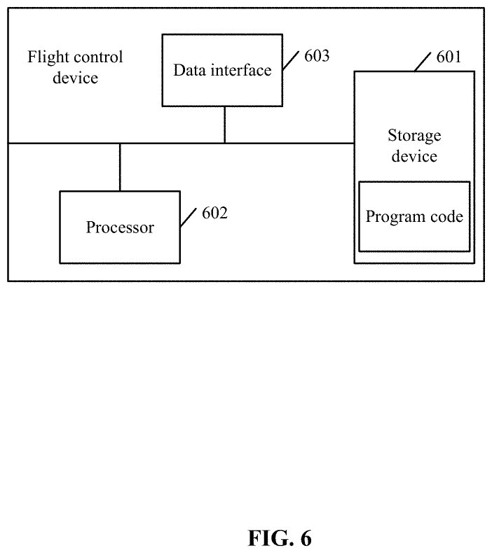

FIG. 6 is a schematic diagram of another flight control device. The flight control device may include a storage device 601, a processor 602, and a data interface 603.

The storage device 601 may include at least one of a volatile memory and a non-volatile memory. In some embodiments, the storage device 601 may include a combination of a volatile memory and a non-volatile memory. The processor 602 may include a central processing unit. The processor 602 may also include a hardware chip. The hardware chip may include at least one of an application-specific integrated circuit (“ASIC”), a programmable logic device (“PLD”), or a combination thereof. The hardware chip may include a complex programmable logic device (“CPLD”), a field-programmable gate array (“FPGA”), or any combination thereof.

In some embodiments, the storage device 601 may be configured to store program code or instructions. When the program code is executed by the processor 602, the processor 602 may retrieve or read the program code stored in the storage device 601, and execute the program code to perform processes including:
obtaining an environment image captured by the imaging device if a triggering operation configured to trigger the aircraft to enter an image control mode is obtained;
recognizing a hand gesture of the control object of the target user in the environment image; and
generating a control command to control the flight of the aircraft if the recognized hand gesture of the control object is a start-flight hand gesture.

In some embodiments, the triggering operation may include one or more of a point-click operation on a power button of the aircraft, a double-click operation of the power button of the aircraft, a shaking operation of the aircraft, a voice input operation, and a fingerprint input operation.

In some embodiments, the processor 602 may retrieve or read the program code stored in the storage device 601, and execute the program code to perform processes including:
after obtaining the triggering operation, controlling the gimbal carried by the aircraft to rotate to control the imaging device to scan and photograph in a predetermined photographing range; and
obtaining the environment image including the characteristic part of the target user that is captured by the imaging device through scanning and photographing in the predetermined photographing range.

In some embodiments, the processor 602 may retrieve or read the program code stored in the storage device 601, and execute the program code to perform processes including:
during the flight of the aircraft, controlling the imaging device to capture a flight environment image;
recognizing a hand gesture of the control object of the target user in the flight environment image to determine a flight control hand gesture; and
based on the flight control hand gesture, generating a control command to control the aircraft to perform an action corresponding to the control command.

In some embodiments, the processor 602 may retrieve or read the program code stored in the storage device 601, and execute the program code to perform processes including:
generating a height control command to control the aircraft to adjust the height of the aircraft, if the recognized flight control hand gesture of the control object is a height control hand gesture.

In some embodiments, the processor 602 may retrieve or read the program code stored in the storage device 601, and execute the program code to perform processes including:
generating a moving control command to control the aircraft to fly in a direction indicated by the moving control command, if the recognized flight control hand gesture is a moving control hand gesture.

The direction indicated by the moving control command may include: a direction moving away from the control object or a direction moving closer to the control object.

In some embodiments, the processor 602 may retrieve or read the program code stored in the storage device 601, and execute the program code to perform processes including:
generating a drag control command to control the aircraft to fly in a horizontal direction indicated by the drag control command, if the recognized flight control hand gesture is a drag control hand gesture.

In some embodiments, the processor 602 may retrieve or read the program code stored in the storage device 601, and execute the program code to perform processes including:
generating a rotation control command to control the aircraft to fly around the target user in a direction indicated by the rotation control command, if the recognized flight control hand gesture of the control object is a rotation control hand gesture.

In some embodiments, the processor 602 may retrieve or read the program code stored in the storage device 601, and execute the program code to perform processes including:
generating a landing control command to control the aircraft to land, if the recognized flight control hand gesture of the control object is a landing hand gesture.

In some embodiments, the processor 602 may retrieve or read the program code stored in the storage device 601, and execute the program code to perform processes including:
if the flight control hand gesture is not recognized, but the characteristic part of the target user in the flight environment image is recognized, then, based on the characteristic part of the target user, controlling the aircraft to use the target user as a tracking target, and to follow the movement of the target user.

In some embodiments, following the movement of the target user may include:
adjusting a photographing state, such that the target user is included in the images captured by the imaging device; adjusted the photographing state may include adjusting one or more of a location of the aircraft, an attitude of the gimbal carried by the aircraft, and an attitude of the aircraft.

In some embodiments, the processor 602 may retrieve or read the program code stored in the storage device 601, and execute the program code to perform processes including:
generating a photographing control command to control the imaging device of the aircraft to capture a target image, if the recognized flight control gesture of the control object is a photographing hand gesture.

In some embodiments, the processor 602 may retrieve or read the program code stored in the storage device 601, and execute the program code to perform processes including:
generating a video-recording control command to control the imaging device of the aircraft to capture videos, if the recognized flight control hand gesture of the control object is a video-recording hand gesture; and
while the imaging device of the aircraft captures the videos, generating an ending control command to control the imaging device of the aircraft to end the video recording, if the video-recording hand gesture of the control object is recognized again.

In some embodiments, the processor 602 may retrieve or read the program code stored in the storage device 601, and execute the program code to perform processes including:
determining that a replacement user is a new target user if the flight control hand gesture of the control object of the target user is not recognized, and if a replacement control hand gesture of a control object of the replacement user is recognized; and
recognizing the control object of the new target user and the replacement control hand gesture, and generating, based on the replacement control hand gesture, a control command to control the aircraft to perform an action corresponding to the control command.

In some embodiments, during the flight of the aircraft, the flight control device may control the imaging device to capture a flight environment image. The flight control device may recognize the hand gesture of the control object of the target user in the flight environment image to determine the flight control hand gesture. Based on the flight control hand gesture, the flight control device may generate a control command to control the aircraft to perform an action corresponding to the control command. Through the disclosed methods, by hand gesture recognition, controlling the aircraft to perform an action indicated by the hand gesture may be achieved, thereby simplifying the aircraft control operations. Fast control of the aircraft can be achieved, and the aircraft control efficiency can be increased.

In some embodiments, the present disclosure provides an aircraft, including an aircraft body, and a propulsion system provided on the aircraft body and configured to provide a propulsion force for the flight of the aircraft. The aircraft may also include a processor configured to obtain an environment image captured by an imaging device. The processor may also be configured to determine a characteristic part of the target user based on the environment image, and determine a target image area based on the characteristic part. The processor may further recognize the control object of the target user in the target image area, and generate a control command based on the control object to control the flight of the aircraft.

In some embodiments, the processor may be configured to execute the following steps:
recognizing an action characteristic of the control object, and obtaining a control command based on the action characteristic of the control object; and
controlling the flight of the aircraft based on the control command.

In some embodiments, the control object may include a palm of the target user.

In some embodiments, the processor may be configured to execute the following steps:
if the status parameter of the target user satisfies a first predetermined condition, determining the characteristic part of the target user as a first characteristic part; and
based on the first characteristic part, determining the target image area in which the first characteristic part is located, and recognizing the control object of the target user in the target image area.

In some embodiments, the status parameter of the target user may include: a proportion of a size of an image area in which the target user is located in the environment image (e.g., relative to the size of the environment image). The first predetermined condition that the status parameter of the target user may satisfy may include: the proportion of the size of the image area in which the target user is located in the environment image is smaller than or equal to a first predetermined proportion value; or
the status parameter of the target user may include a distance between the target user and the aircraft; the first predetermined condition that the status parameter of the target user may satisfy may include: the distance between the target user and the aircraft is greater than or equal to a first predetermined distance.

In some embodiments, the first characteristic part includes a human body of the target user.

In some embodiments, the processor may be configured to execute the following steps:
if the status parameter of the target user satisfies a second predetermined condition, determining that the characteristic part of the target user is a second characteristic part; and
based on the second characteristic part of the target user, determining a target image area in which the second characteristic part is located, and recognizing the control object of the target user in the target image area.

In some embodiments, the status parameter of the target user may include a proportion of the size of image area where the target user is located in the environment image (e.g., relative to the size of the environment image); the second predetermined condition that the status parameter of the target user may satisfy may include: the proportion of the image area in which the target user is located in the environment image is greater than or equal to the second predetermined value; or
the status parameter of the target user may include a distance between the target user and the aircraft; the second predetermined condition that the status parameter of the target user may satisfy may include: the distance between the target user and the aircraft is smaller than or equal to a second predetermined distance.

In some embodiments, the second characteristic part may include a head of the target user, or the second characteristic part may include a head and a shoulder.

In some embodiments, the processor may be configured to execute the following steps:
recognizing at least one control object in the target image area;
based on the characteristic part of the target user, determining joints of the target user; and
based on the determined joints, determining the control object of the target user from the at least one control object.

In some embodiments, the processor may be configured to execute the following steps:
determining a target joint from the determined joints; and
determining that a control object in the at least one control object that is closest to the target joint as the control object of the target user.

The detailed implementation of the processor of the aircraft described above may refer to the descriptions of the flight control method discussed with reference to FIG. 2.

In some embodiments, the aircraft may be a multi-rotor unmanned aerial vehicle, such as a four-rotor unmanned aerial vehicle, or a six-rotor unmanned aerial vehicle. The propulsion system may include one or more of a motor, an electric speed control (“ESC”), and a propeller. The motor may cause the propeller to rotate, and the ESC may control the rotating speed of the motor of the aircraft.

In some embodiments, the present disclosure provides another aircraft, including an aircraft body, and a propulsion system provided on the aircraft body, and configured to provide a propulsion force for flight. The aircraft may also include a processor configured to obtain an environment image captured by an imaging device when obtaining a triggering operation configured to trigger the aircraft to enter an image control mode. The processor may recognize the hand gesture of the control object of the target user in the environment image. If the recognized hand gesture of the control object is a start-flight hand gesture, the processor may generate a control command to control the aircraft to take off.

In some embodiments, the triggering operation may include one or more of: a point-click operation on a power button of the aircraft, a double-click operation of the power button of the aircraft, a shaking operation of the aircraft, a voice input operation, and a fingerprint input operation.

In some embodiments, the processor may be configured to execute the following steps:
after obtaining the triggering operation, controlling the gimbal carried by the aircraft to rotate to control the imaging device to scan and photograph in a predetermined photographing range; and
obtaining the environment image including the characteristic part of the target user that is captured by the imaging device through scanning and photographing in the predetermined photographing range.

In some embodiments, the processor may be configured to execute the following steps:
during the flight of the aircraft, controlling the imaging device to capture a flight environment image;
recognizing a hand gesture of the control object of the target user in the flight environment image to determine a flight control hand gesture; and
based on the flight control hand gesture, generating a control command to control the aircraft to perform an action corresponding to the control command.

In some embodiments, the processor may be configured to execute the following steps:
generating a height control command to control the aircraft to adjust the height of the aircraft, if the recognized flight control hand gesture of the control object is a height control hand gesture.

In some embodiments, the processor may be configured to execute the following steps:
generating a moving control command to control the aircraft to fly in a direction indicated by the moving control command, if the recognized flight control hand gesture is a moving control hand gesture.

The direction indicated by the moving control command may include: a direction moving away from the control object or a direction moving closer to the control object.

In some embodiments, the processor may be configured to execute the following steps:
generating a drag control command to control the aircraft to fly in a horizontal direction indicated by the drag control command, if the recognized flight control hand gesture is a drag control hand gesture.

In some embodiments, the processor may be configured to execute the following steps:
generating a rotation control command to control the aircraft to fly around the target user in a direction indicated by the rotation control command, if the recognized flight control hand gesture of the control object is a rotation control hand gesture.

In some embodiments, the processor may be configured to execute the following steps:
generating a landing control command to control the aircraft to land, if the recognized flight control hand gesture of the control object is a landing hand gesture.

In some embodiments, the processor may be configured to execute the following steps:
if the flight control hand gesture is not recognized, but the characteristic part of the target user in the flight environment image is recognized, then, based on the characteristic part of the target user, controlling the aircraft to use the target user as a tracking target, and to follow the movement of the target user.

In some embodiments, following the movement of the target user may include: adjusting a photographing state. In the adjusting photographing state, the target user is included in the images captured by the imaging device; adjusted the photographing state may include adjusting one or more of a location of the aircraft, an attitude of the gimbal carried by the aircraft, and an attitude of the aircraft.

In some embodiments, the processor may be configured to execute the following steps:
generating a photographing control command to control the imaging device of the aircraft to capture a target image, if the recognized flight control gesture of the control object is a photographing hand gesture.

In some embodiments, the processor may be configured to execute the following steps:
generating a video-recording control command to control the imaging device of the aircraft to capture videos, if the recognized flight control hand gesture of the control object is a video-recording hand gesture;

While the imaging device of the aircraft captures the videos, generating an ending control command to control the imaging device of the aircraft to end the video recording, if the video-recording hand gesture of the control object is recognized again.

In some embodiments, the processor may be configured to execute the following steps:
determining that a replacement user is a new target user if the flight control hand gesture of the control object of the target user is not recognized, and if a replacement control hand gesture of a control object of the replacement user is recognized; and
recognizing the control object of the new target user and the replacement control hand gesture, and generating, based on the replacement control hand gesture, a control command to control the aircraft to perform an action corresponding to the control command.

The detailed implementation of the processor may refer to the descriptions of the corresponding methods discussed above in connection with FIG. 3 or FIG. 4. The description of the aircraft can refer to the above descriptions of the aircraft.

In some embodiments, the present disclosure provides a flight control system, including a flight control device and an aircraft;

The aircraft may be configured to control the imaging device carried by the aircraft to capture an environment image, and to transmit the environment image to the flight control device;

The flight control device may be configured to obtain the environment image captured by the imaging device; determine a characteristic part of the target user based on the environment image; determine a target image area based on the characteristic part, and recognize the control object of the target user in the target image area; and generate a control command to control the flight of the aircraft.

In some embodiments, in response to the flight control command, the flight control device may control the aircraft to fly and perform an action corresponding to the flight control command.

In some embodiments, the flight control device is configured to recognize an action characteristic of the control object, obtain a control command based on the action characteristic of the control object, and control the flight of the aircraft based on the control command.

In some embodiments, if the status parameter of the target user satisfies a first predetermined condition, the flight control device may determine that the characteristic part of the target user is a first characteristic part; based on the first characteristic part, the flight control device may determine the target image area in which the first characteristic part is located, and recognize the control object of the target user in the target image area.

In some embodiments, the status parameter of the target user may include: a proportion of a size of an image area in which the target user is located in the environment image (e.g., relative to the size of the environment image). The first predetermined condition that the status parameter of the target user may satisfy may include: the proportion of the size of the image area in which the target user is located in the environment image is smaller than or equal to a first predetermined proportion value; or the status parameter of the target user may include a distance between the target user and the aircraft; the first predetermined condition that the status parameter of the target user may satisfy may include: the distance between the target user and the aircraft is greater than or equal to a first predetermined distance.

In some embodiments, the first characteristic part includes a human body of the target user.

In some embodiments, if the status parameter of the target user satisfies a second predetermined condition, the flight control device may determine that the characteristic part of the target user is a second characteristic part; based on the second characteristic part of the target user, the flight control device may determine a target image area in which the second characteristic part is located, and recognize the control object of the target user in the target image area.

In some embodiments, the status parameter of the target user may include a proportion of the size of image area where the target user is located in the environment image (e.g., relative to the size of the environment image); the second predetermined condition that the status parameter of the target user may satisfy may include: the proportion of size of the image area in which the target user is located in the environment image is greater than or equal to the second predetermined value; or the status parameter of the target user may include a distance between the target user and the aircraft; the second predetermined condition that the status parameter of the target user may satisfy may include: the distance between the target user and the aircraft is smaller than or equal to a second predetermined distance.

In some embodiments, the second characteristic part may include a head of the target user, or the second characteristic part may include a head and a shoulder.

In some embodiments, the flight control device may be configured to recognize at least one control object in the target image area; based on the characteristic part of the target user, determine joints of the target user; based on the determined joints, determine the control object of the target user from the at least one control object.

In some embodiments, the flight control device may determine a target joint from the determined joints; and determine that a control object in the at least one control object that is closest to the target joint as the control object of the target user.

In some embodiments, the flight control device may control the imaging device to obtain an environment image. The flight control device may determine a characteristic part of a target user, and determine a target image area based on the characteristic part. The flight control device may recognize or identify a control object of the target user in the target image area, thereby generating a control command based on the control object to control the flight of the aircraft. Through the disclosed methods, the control object of the target user is recognized, and the flight of the aircraft can be controlled based on recognition of the action characteristics of the control object. The control operations are simplified, and the flight control efficiency is increased.

In some embodiments, the present disclosure provides another flight control system, including a flight control device and an aircraft.

In some embodiments, the flight control device may obtain an environment image captured by an imaging device when obtaining a triggering operation configured to trigger the aircraft to enter an image control mode. The flight control device may recognize the hand gesture of the control object of the target user in the environment image. If the recognized hand gesture of the control object is a start-flight hand gesture, the flight control device may generate a control command to control the aircraft to take off.

The aircraft may be configured to take off in response to the takeoff control command.

In some embodiments, the triggering operation may include one or more of: a point-click operation on a power button of the aircraft, a double-click operation of the power button of the aircraft, a shaking operation of the aircraft, a voice input operation, and a fingerprint input operation.

In some embodiments, after obtaining the triggering operation, the flight control device may control the gimbal carried by the aircraft to rotate to control the imaging device to scan and photograph in a predetermined photographing range; and obtain the environment image including the characteristic part of the target user that is captured by the imaging device through scanning and photographing in the predetermined photographing range.

In some embodiments, during the flight of the aircraft, the flight control device may control the imaging device to capture a flight environment image; recognize a hand gesture of the control object of the target user in the flight environment image to determine a flight control hand gesture; and based on the flight control hand gesture, generate a control command to control the aircraft to perform an action corresponding to the control command.

In some embodiments, the flight control device may generate a height control command to control the aircraft to adjust the height of the aircraft, if the recognized flight control hand gesture of the control object is a height control hand gesture.

In some embodiments, the flight control device may generate a moving control command to control the aircraft to fly in a direction indicated by the moving control command, if the recognized flight control hand gesture is a moving control hand gesture; the direction indicated by the moving control command may include: a direction moving away from the control object or a direction moving closer to the control object.

In some embodiments, the flight control device may generate a drag control command to control the aircraft to fly in a horizontal direction indicated by the drag control command, if the recognized flight control hand gesture is a drag control hand gesture.

In some embodiments, the flight control device may generate a rotation control command to control the aircraft to fly around the target user in a direction indicated by the rotation control command, if the recognized flight control hand gesture of the control object is a rotation control hand gesture.

In some embodiments, the flight control device may generate a landing control command to control the aircraft to land, if the recognized flight control hand gesture of the control object is a landing hand gesture.

In some embodiments, if the flight control hand gesture is not recognized, but the characteristic part of the target user in the flight environment image is recognized, then, based on the characteristic part of the target user, the flight control device may control the aircraft to use the target user as a tracking target, and to follow the movement of the target user.

In some embodiments, following the movement of the target user may include: adjusting a photographing state. In the adjusting photographing state, the target user is located in the images captured by the imaging device; adjusted the photographing state may include adjusting one or more of a location of the aircraft, an attitude of the gimbal carried by the aircraft, and an attitude of the aircraft.

In some embodiments, the flight control device may generate a photographing control command to control the imaging device of the aircraft to capture a target image, if the recognized flight control gesture of the control object is a photographing hand gesture.

In some embodiments, the flight control device may generate a video-recording control command to control the imaging device of the aircraft to capture videos, if the recognized flight control hand gesture of the control object is a video-recording hand gesture; while the imaging device of the aircraft captures the videos, the flight control device may generate an ending control command to control the imaging device of the aircraft to end the video recording, if the video-recording hand gesture of the control object is recognized again.

In some embodiments, the flight control device may determine that a replacement user is a new target user if the flight control hand gesture of the control object of the target user is not recognized, and if a replacement control hand gesture of a control object of the replacement user is recognized; the flight control device may recognize the control object of the new target user and the replacement control hand gesture, and generating, based on the replacement control hand gesture, a control command to control the aircraft to perform an action corresponding to the control command.

In some embodiments, during the flight of the aircraft, the flight control device may control the imaging device to obtain a flight environment image. The flight control device may recognize a hand gesture of the control object of the target user in the flight environment image to determine a flight control hand gesture. Based on the flight control hand gesture, the flight control device may generate a control command to control the aircraft to perform an action corresponding to the control command. Through the disclosed methods, the aircraft may be controlled to perform an action indicated by a hand gesture recognized through a hand gesture recognition process, thereby simplifying the operations of controlling the aircraft. Accordingly, fast control of the aircraft can be achieved, and the aircraft control efficiency can be increased.

The present disclosure also provides a non-transitory computer-readable storage medium, which may store computer instructions or codes. When the computer instructions or codes are executed by a processor, the flight control methods of FIG. 1a, FIG. 2, FIG. 3, and FIG. 4 may be performed, and the flight control device of FIG. 5 or FIG. 6 may be realized.

The computer-readable storage medium may be an internal storage device included in the disclosed flight control device and/or system, such as a hard disk or a memory. In some embodiments, the computer-readable storage medium may be an external device external to the disclosed flight control device and/or system. The computer-readable storage medium may be a plug-and-play hard disk, a smart media card (“SMC”), a secure digital card (“SD”), a flash card, etc. The computer-readable storage medium may include both an internal storage medium of the disclosed device and/or system, and an external storage medium of the disclosed device and/or system. The computer-readable storage medium may be configured to store the computer program code and other programs or data. In some embodiments, the computer-readable storage medium may be configured to temporarily store data that have already been output or that will be output.

A person having ordinary skill can appreciate that all or some of the steps of the disclosed methods may be implemented through hardware that implements the computer program code. The computer program code may be stored in a computer-readable storage medium. When the computer program code is executed, the steps of the disclosed methods may be performed. The non-transitory computer-readable storage medium can be any medium that can store program codes, for example, a magnetic disk, an optical disk, a read-only memory (“ROM”), and a random-access memory (“RAM”), etc.

Other embodiments of the present disclosure will be apparent to those skilled in the art from consideration of the specification and practice of the embodiments disclosed herein. It is intended that the specification and examples be considered as example only and not to limit the scope of the present disclosure, with a true scope and spirit of the invention being indicated by the following claims. Variations or equivalents derived from the disclosed embodiments also fall within the scope of the present disclosure.

What is claimed is:

1. A method for controlling flight of an aircraft carrying an imaging device, the imaging device being mounted at a gimbal carried by the aircraft, the method comprising:
in response to receiving a triggering operation that triggers the aircraft to operate in an image control mode, obtaining an environment image captured by the imaging device, including:
after obtaining the triggering operation, controlling the gimbal to rotate to control the imaging device to scan and photograph in a predetermined photographing range; and
obtaining the environment image including a characteristic part of the target user that is captured by the imaging device through scanning and photographing in the predetermined photographing range;
recognizing a gesture of a target user in the environment image; and
in response to recognizing that the gesture of the target user is a start-flight gesture, generating a takeoff control command to control the aircraft to take off.

2. The method of claim 1, wherein the triggering operation includes a point-click operation on a power button of the aircraft or a double-click operation on the power button of the aircraft.

3. The method of claim 1, wherein the characteristic part of the target user includes a head of the target user.

4. The method of claim 1, further comprising:
during a flight of the aircraft, controlling the imaging device to capture a flight environment image;
recognizing a gesture of the target user in the flight environment image to determine a flight control gesture; and
based on the flight control gesture, generating a control command to control the aircraft to perform an action corresponding to the control command.

5. The method of claim 4, wherein based on the flight control gesture, generating the control command to control the aircraft to perform the action corresponding to the control command includes:
in response to recognizing that the flight control gesture is a height control gesture, generating a height control command to control the aircraft to adjust a flight height of the aircraft.

6. The method of claim 4, wherein based on the flight control gesture, generating the control command to control the aircraft to perform the action corresponding to the control command includes:
in response to recognizing that the flight control gesture is a moving control gesture, generating a moving control command to control the aircraft to fly in a direction indicated by the moving control command, the direction indicated by the moving control command including a direction moving away from the target user or a direction moving closer to the target user.

7. The method of claim 4, wherein based on the flight control gesture, generating the control command to control the aircraft to perform the action corresponding to the control command includes:
in response to recognizing that the flight control gesture is a drag control gesture, generating a drag control command to control the aircraft to fly in a horizontal direction indicated by the drag control command.

8. The method of claim 4, wherein based on the flight control gesture, generating the control command to control the aircraft to perform the action corresponding to the control command includes:
in response to recognizing that the flight control gesture is a rotation control gesture, generating a rotation control command to control the aircraft to rotatably fly in a direction indicated by the rotation control command.

9. The method of claim 4, wherein based on the flight control gesture, generating the control command to control the aircraft to perform the action corresponding to the control command includes:
in response to recognizing that the flight control gesture is a landing control gesture, generating a landing control command to control the aircraft to land.

10. The method of claim 4, wherein based on the flight control gesture, generating the control command to control the aircraft to perform the action corresponding to the control command includes:
in response to not recognizing the flight control gesture, but recognizing the characteristic part of the target user in the flight environment image, controlling, based on the characteristic part of the target user, the aircraft to use the target user as a tracking target and to follow a movement of the target user.

11. The method of claim 10, wherein controlling the aircraft to follow the movement of the target user includes:
adjusting a photographing state, to cause the target user to be included in an image captured by the imaging device after the photographing state is adjusted;
wherein adjusting the photographing state includes adjusting at least one of a location of the aircraft, an attitude of the gimbal carried by the aircraft, or an attitude of the aircraft.

12. The method of claim 4, wherein based on the flight control gesture, generating the control command to control the aircraft to perform the action corresponding to the control command includes:
in response to recognizing that the flight control gesture is a photographing gesture, generating a photographing control command to control the imaging device of the aircraft to capture a target image.

13. The method of claim 4, wherein based on the flight control gesture, generating the control command to control the aircraft to perform the action corresponding to the control command includes:
in response to recognizing that the flight control gesture is a video-recording gesture, generating a video-recording control command to control the imaging device of the aircraft to capture a video; and
while the imaging device of the aircraft captures the video, generating an ending control command to control the imaging device of the aircraft to stop capturing the video in response to recognizing the video-recording gesture of the target user again.

14. The method of claim 4, wherein based on the flight control gesture, generating the control command to control the aircraft to perform the action corresponding to the control command includes:
in response to not recognizing the flight control gesture of the target user, but recognizing a replacement control gesture of a new target user, generating, based on the replacement control gesture, the control command to control the aircraft to perform the action corresponding to the control command.

15. A device for controlling flight of an aircraft carrying an imaging device, the imaging device being mounted at a gimbal carried by the aircraft, the device comprising:
a storage device configured to store instructions;
a processor configured to execute the instructions to:
in response to receiving a triggering operation that triggers the aircraft to operate in an image control mode, obtain an environment image captured by the imaging device, including:
after obtaining the triggering operation, controlling the gimbal to rotate to control the imaging device to scan and photograph in a predetermined photographing range; and
obtaining the environment image including a characteristic part of the target user that is captured by the imaging device through scanning and photographing in the predetermined photographing range;
recognize a gesture of a target user in the environment image; and
in response to recognizing that the gesture of the target user is a start-flight gesture, generate a takeoff control command to control the aircraft to take off.

16. The device of claim 15, wherein the processor is further configured to execute the instructions to:
during a flight of the aircraft, control the imaging device to capture a flight environment image;
recognize a gesture of the target user in the flight environment image to determine a flight control gesture; and
based on the flight control gesture, generate a control command to control the aircraft to perform an action corresponding to the control command.

17. The device of claim 16, wherein the processor is further configured to execute the instructions to:
in response to recognizing that the flight control gesture is a rotation control gesture, generate a rotation control command to control the aircraft to rotatably fly in a direction indicated by the rotation control command.

18. The device of claim 16, wherein the processor is further configured to execute the instructions to:
in response to recognizing that the flight control gesture is a landing control gesture, generate a landing control command to control the aircraft to land.

19. The device of claim 16, wherein the processor is further configured to execute the instructions to:
in response to not recognizing the flight control gesture, but recognizing the characteristic part of the target user in the flight environment image, control, based on the characteristic part of the target user, the aircraft to use the target user as a tracking target and to follow a movement of the target user.

20. The device of claim 16, wherein the processor is further configured to execute the instructions to:
in response to not recognizing the flight control gesture of the target user, but recognizing a replacement control gesture of a new target user, generate, based on the replacement control gesture, the control command to control the aircraft to perform the action corresponding to the control command.
